(19) United States
(12) Patent Application Publication
(10) Pub. No.: US 2015/0306712 A1
(43) Pub. Date: Oct. 29, 2015

(54) EMBEDDED SECTION HEATER FOR BONDING COMPOSITE STRUCTURES, AND ASSOCIATED APPARATUSES AND METHODS

(71) Applicant: UNIVERSITY OF WASHINGTON THROUGH ITS CENTER FOR COMMERCIALIZATION, Seattle, WA (US)

(72) Inventors: Santosh Devasia, Lake Forest Park, WA (US); Mark Tuttle, Seattle, WA (US)

(21) Appl. No.: 14/651,769

(22) PCT Filed: Jan. 7, 2014
(86) PCT No.: PCT/US2014/010531

§ 371 Date: Jun. 12, 2015

Related U.S. Application Data
(60) Provisional application No. 61/749,753, filed on Jan. 7, 2013.
(60) Provisional application No. 61/822,826, filed on May 13, 2013.
(60) Provisional application No. 61/912,742, filed on Dec. 6, 2013.

(51) Int. Cl. B23P 6/00

(52) U.S. Cl. CPC B23P 6/00

(57) ABSTRACT

Apparatuses and associated methods for bonding composite structures are disclosed herein. In one embodiment, a method for repairing the composite structures can include disposing an inner temperature sensor array proximate to an embedded heater, and an outer temperature sensor array away from the embedded heater. Heat transfer across a repair stack can be calculated or estimated based on the outputs of the temperature sensor arrays. In some embodiments, a target power of the embedded heater can be optimized based on the on the outputs of the temperature sensor arrays. In some embodiments, the embedded heater can be segmented into heater elements for improved temperature control of a film adhesive. In some embodiments, carbon fibers in the heater elements can be patterned differently to, at least in part, control electrical resistance of the heater elements.

### CROSS-REFERENCE TO RELATED APPLICATIONS

This application claims the benefit of pending (a) U.S. Provisional Application No. 61/749,753, filed Jan. 7, 2013, (b) U.S. Provisional Application No. 61/822,826, filed May 13, 2013, and (c) U.S. Provisional Application No. 61/912,742, filed Dec. 6, 2013.

### TECHNICAL FIELD

The present technology is generally related to bonding composite structures and associated apparatuses and methods. In particular, several embodiments of the present technology are directed to producing uniform temperature field at the bond area by controlling power distribution of an embedded heater.

### BACKGROUND

Composite structures are made of two or more constituent materials that generally have significantly different properties. Typically, the individual constituent materials remain separate and distinct within the composite structure. The constituent materials are selected and combined to produce a resulting composite structure with improved characteristics, e.g., stronger, lighter, less expensive than traditional materials. Some composite structures are well suited for use in airplanes because of their relatively low weight and high strength, coupled with their resistance to cracking and fatigue.

Under some use conditions, however, composite structures may be susceptible to damage. For example, moisture penetration and subsequent moisture expansion may cause delamination of the composite structure. Additionally, excessive mechanical or thermal loads may also damage composite structures. In some cases with relatively large and/or expensive composite structures, for example, repair of the damaged area may be more cost effective than the replacement of the entire composite structure. Conventional bonded composite structure repair techniques include stacking an adhesive and several layers of repair plies over the damaged area and then heating the stack till the adhesive and the repair plies cure. The repair plies fill the damaged area and become generally firmly attached to the composite structure after the adhesive cures. Excessive repair plies, if any, at the damaged area can be trimmed to smooth the repaired area.

FIG. 1, for example, is a partially schematic cross-sectional view of a composite structure repair stack 1000 in accordance with conventional technology. A composite structure 10 has a scarfed surface 15 that needs to be repaired. With the illustrated conventional technology, a film adhesive 20 is applied over the scarfed surface 15. Next, repair plies 25 are placed over the film adhesive 20. The repair plies 25 can be shaped to generally fill the scarfed surface 15 such that the scarfed surface becomes level with the surrounding undamaged surface of the composite structure 10. First and second cover composites 30, 35 seal off the repair plies 25 from the outside environment, while still allowing outgassing from the repair plies 25 and/or film adhesive 20 away from the composite structure 10. A surface heater 40 provides heat needed for curing the film adhesive 20. The surface heater 40 can be an electrical resistor connected to a power supply (not shown). A third cover composite 45 can be placed over the surface heater 40 to reduce environmental heat losses of the repair stack 1000, while still allowing outgassing from the adhesive and repair plies. After the film adhesive is cured, the layers above the repair plies 25 are removed and the repair plies 25 are trimmed, polished, and/or painted, as appropriate. Generally, a relatively uniform temperature of the film adhesive 20 during the curing process improves the strength of a bond between the repair plies 25 and the composite structure 10. However, with the illustrated repair stack 1000, controlling the temperature of the film adhesive 20 and/or repair plies 25 is difficult due to changing heat conductivity and/or specific heat of the film adhesive 20 and repair plies 25 as the curing process progresses. Additionally, generally poor thermal conductivity of the materials in the repair stack 1000 (e.g., film adhesive, repair plies, cover composites) results in significant temperature gradients through the stack, making it difficult to precisely control temperature at the relevant layers (e.g., film adhesive 20). Furthermore, heat losses at the outer surface heater 40 (i.e., at the side facing away from scarfed surface 15) and through the composite structure 10 can be relatively significant, thus further impeding precise temperature control at the film adhesive 20.

FIG. 2 is a partially schematic isometric view of a composite structure repair system 2000 in accordance with another embodiment of the conventional technology. The third cover composite 45 covers the scarfed surface 15 and one or more additional cover composites, the repair plies, and the adhesive (not visible). With the illustrated conventional technology, a radiation source 50 emits radiation 55 that heats the third cover composite 45 and the layers beneath it. Heat provided by the radiation source 50 promotes curing of the film adhesive, which secures the repair plies to the scarfed surface 15. However, with the illustrated repair stack 2000, precise control of the adhesive curing is also difficult. For example, substructures under the composite structure 10 can lead to uneven heat loss leading to uneven temperatures in the adhesive and the repair plies when heating with the radiation source 50. As a result, certain areas of the film adhesive can be under-heated, while the surrounding area of the composite structure 10 can be over-heated, depending on the irradiation of the third cover composite 45 and the surrounding area. Furthermore, as explained above with reference to FIG. 1, temperature control of the film adhesive is generally difficult due to relatively high temperature gradients across the repair stack 2000.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIG. 1 is a partially schematic cross-sectional view of a composite structure repair stack configured in accordance with conventional technology.

FIG. 2 is a partially schematic isometric view of a composite structure repair system configured in accordance with another embodiment of conventional technology.

FIG. 3 is a partially schematic cross-sectional view of a composite structure repair stack configured in accordance with the present technology.

FIG. 4 is a partially schematic plan view of an embedded heater configured in accordance with the present technology.

FIG. 5A is a partially schematic cross-sectional view of a composite structure repair stack configured in accordance with the present technology.

FIG. 5B is a partially schematic plan view of a temperature sensor array configured in accordance with an embodiment of the present technology.

FIG. 5C is a graph illustrating temperature sensor array output configured in accordance with embodiments of the present technology.

FIG. 6 is a flow chart of a method for determining parameters of the embedded heater in accordance with an embodiment of the present technology.

FIG. 7 is a partially schematic cross-sectional view of a composite structure repair system configured in accordance with an embodiment of the present technology.

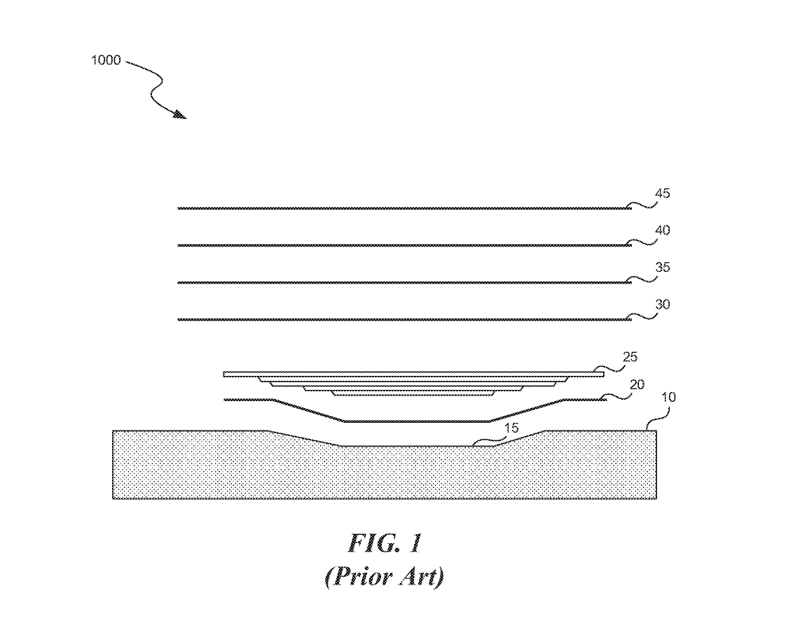

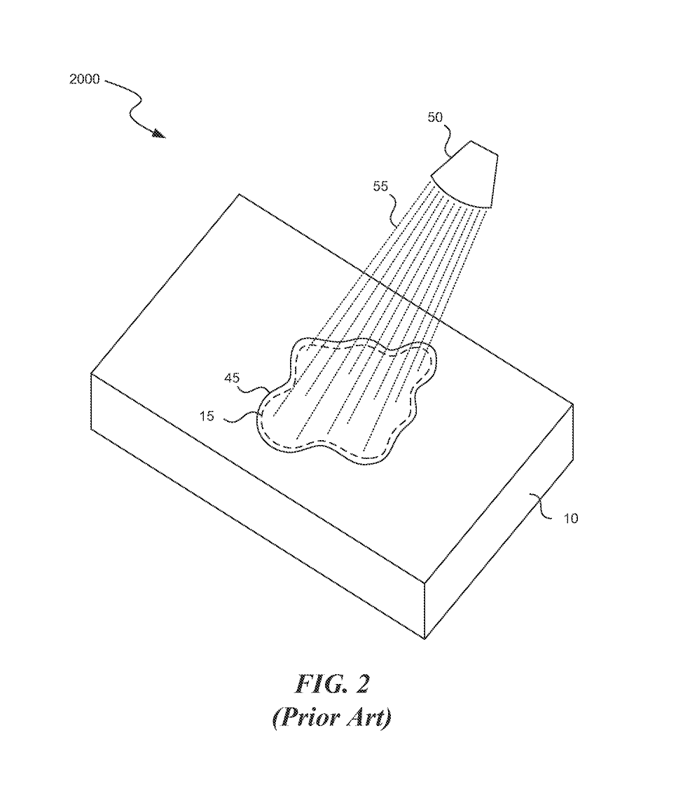

### DETAILED DESCRIPTION

The present technology relates to systems and methods for producing and repairing composite structures. In some embodiments, an embedded heater can be placed between the scarfed surface and the repair plies. Generally, close proximity of the heater to repair plies and the adjacent film adhesive promotes a more uniform and better-controlled temperature of the repair plies and film adhesive. The embedded heater can be segmented and energized per-segment for improved control of power density of the embedded heater. For example, the segments of the embedded heater can be energized at different voltages and/or the segments can have different electrical resistances resulting in correspondingly different power densities. In some embodiments, the embedded heater can be constructed of carbon fibers that are certified for airplane use, therefore making the resulting combination of the embedded heater, cured film adhesive, and repair plies airworthy.

In some embodiments, for example, the repair stack can include two sets of temperature sensors—one being proximate to the embedded heater at the scarfed surface and the other being proximate to the outer surface of the repair stack. When the embedded heater is energized, outputs of the temperature sensors can be obtained and used to calculate the effective heat transfer properties through the repair stack. Knowing the heat transfer properties can help to optimize power density of the embedded heater such that temperature distribution around the repair plies is uniform or close to uniform. After calculating and/or experimentally determining desired power density of the embedded heater, the temperature sensors that are proximate to the embedded heater can be removed, and replaced by the film adhesive. The embedded heater can be energized at the power density distribution that results in a generally uniform temperature distribution around the film adhesive and repair plies, thus improving quality of the resulting bond line. In some embodiments, the curing process can be improved by a feedback loop that reads the outputs of the temperature sensors that are proximate to the outer surface of the repair stack and then adjusts the power of the embedded heater to further optimize temperature distribution at the film adhesive.

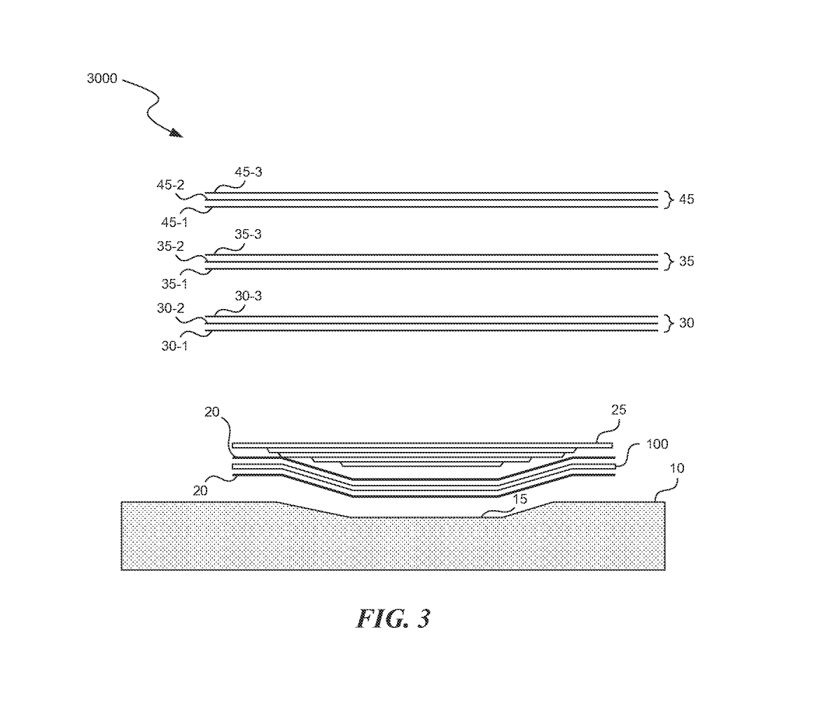

Specific details of several embodiments of the present technology are described herein with reference to FIGS. 3-7. Additionally, other embodiments of the present technology can have different configurations, components, or procedures than those described herein. For example, other embodiments can include additional elements and features beyond those described herein, or other embodiments may not include several of the elements and features shown and described herein.

FIG. 3 is a partially schematic cross-sectional view of a composite structure repair stack 3000 configured in accordance with the present technology. The scarfed surface 15 of the composite structure 10 is repaired by bonding the repair plies 25 to the scarfed surface 15. In the illustrated embodiment, the film adhesive 20 is applied along both sides of the embedded heater 100: between the embedded heater 100 and the scarfed surface 15, and between the embedded heater 100 and the repair plies 25. Generally, the film adhesive 20 is applied in its uncured state. To achieve its full bonding strength, the film adhesive 20 undergoes curing at an elevated temperature. A close proximity of the embedded heater 100 to the film adhesive 20 improves temperature uniformity and control at the film adhesive 20 because the thermal resistances are relatively small between the embedded heater and the adjacent film adhesive 20. Generally, a more uniform and better controlled temperature of the film adhesive 20 results in a stronger and more reliable bonding between the repair plies 25 and the composite structure 10. Since the embedded heater 100 can include an approved (e.g., airworthy) material, the embedded heater 100 can remain in the stack after the curing of the film adhesive 20. The illustrated repair stack 3000 includes one embedded heater 100, but two or more embedded heaters may also be used in the stack.

The stack 3000 can include several cover composites. In some embodiments, for example, the first cover composite 30 includes a sealant 30-1, a porous peel ply 30-2, and a perforated release film 30-3. The sealant 30-1 can protect the repair plies 25 and the film adhesive 20 from the environment during the curing of the film adhesive 20. The porous peel ply 30-2 and the perforated release film 30-3 allow outgassing of the film adhesive 20 and/or the repair plies 25 as the stack 3000 is heated by the embedded heater 100. In some embodiments, the second cover composite 35 can include a bleeder fabric 35-1, non-porous release film 35-2, and a caul sheet 35-3. The third cover composite 45 can include a non-porous release film 45-1, a breather cloth 45-2, and a bagging film 45-3. The second cover composite 35 and the third cover composite 45 can provide additional environmental protection and/or thermal insulation to the repair plies 25 and film adhesive 20.

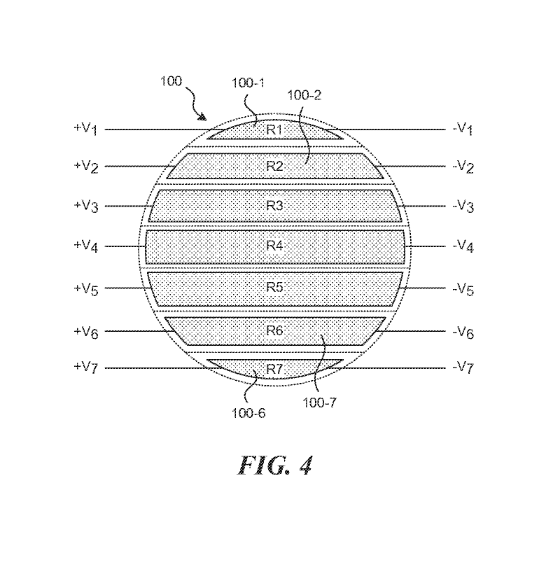

FIG. 4 is a partially schematic plan view of an embedded heater configured in accordance with the present technology. The embedded heater 100 includes seven heater elements 100-1 to 100-7, but other numbers of heater elements are also possible. The heater elements 100-1 to 100-7 can be mutually electrically isolated. Electrical resistances R1-R7 of the heater elements 100-1 to 100-7 generally vary in proportion to a different width and length (i.e., shape) of the heater elements. Therefore, the shape of the heater element can determine, at least in part, power density of the heater element even when the heater elements are connected to same voltage. In some embodiments, however, the heater elements 100-1 to 100-7 may be connected to individual voltage sources (e.g., +/−V1 to +/−V7) to further control power densities of the individual heater elements. In several embodiments, groups of heater elements can be energized at the same voltages.

The embedded heater 100 can be made of carbon fibers that are FAA approved for airworthiness. Some examples of such carbon fibers are the AS4 and IM7 fibers. Therefore, in some embodiments of the present technology, the embedded heater 100 can remain at the repaired scarfed surface after the repair, without reducing the airworthiness of the composite structure. In some embodiments, the carbon fibers in heater elements 100-1 to 100-7 in the same embedded heater 100 can have different patterns, e.g., mat, unidirectional, woven fabric, and/or braided fabric. For the heater elements of the same size, different patterning can change electrical resistance of the heater element. In some embodiments of the present technology, different patterning of the heater elements can be used to control their corresponding electrical resistances and, consequently, power densities when voltage is applied.

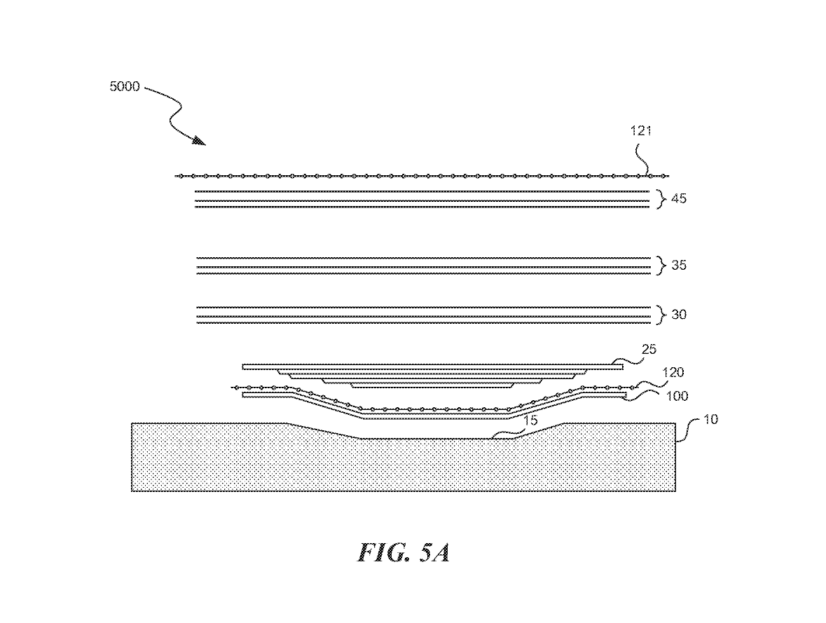

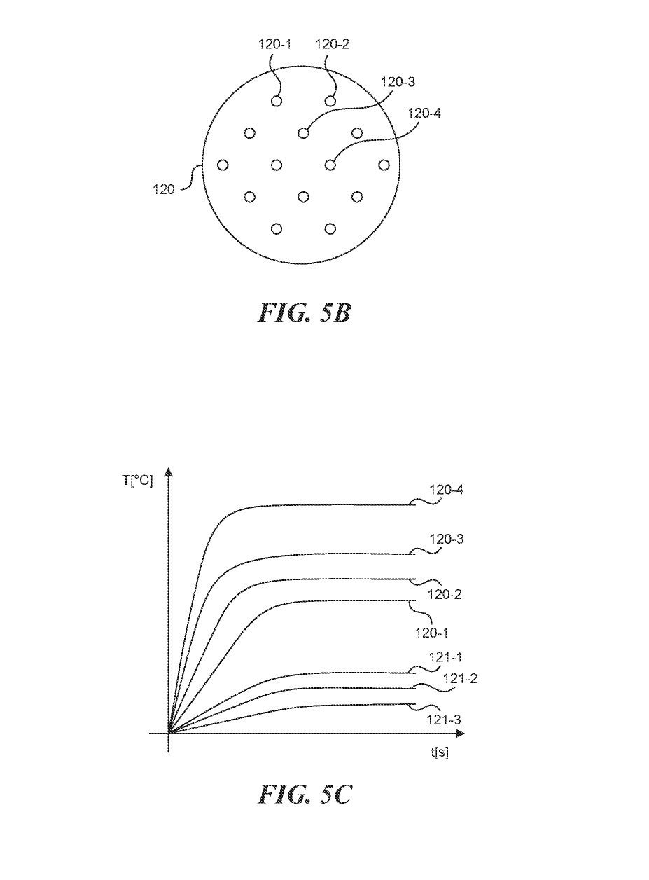

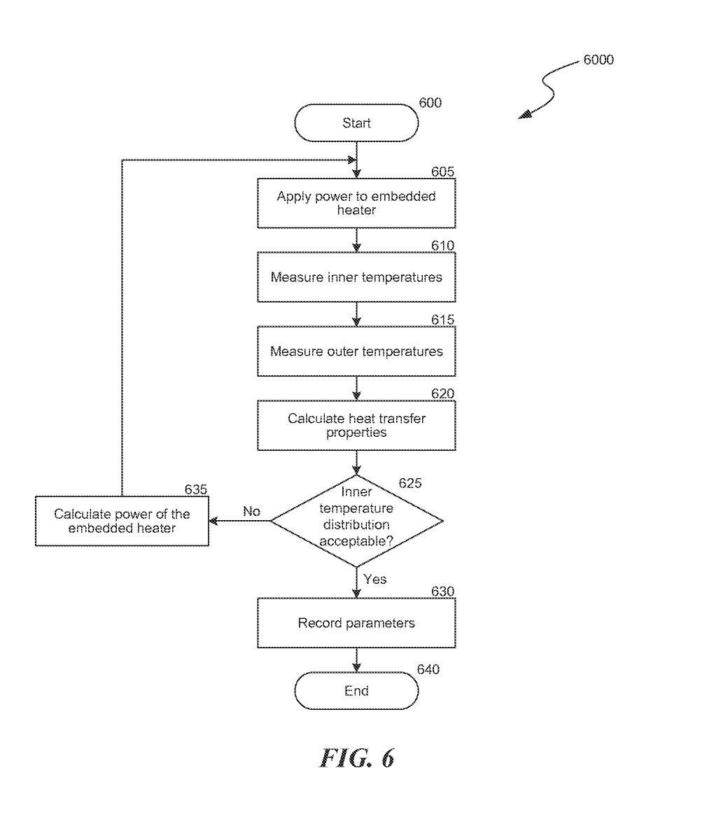

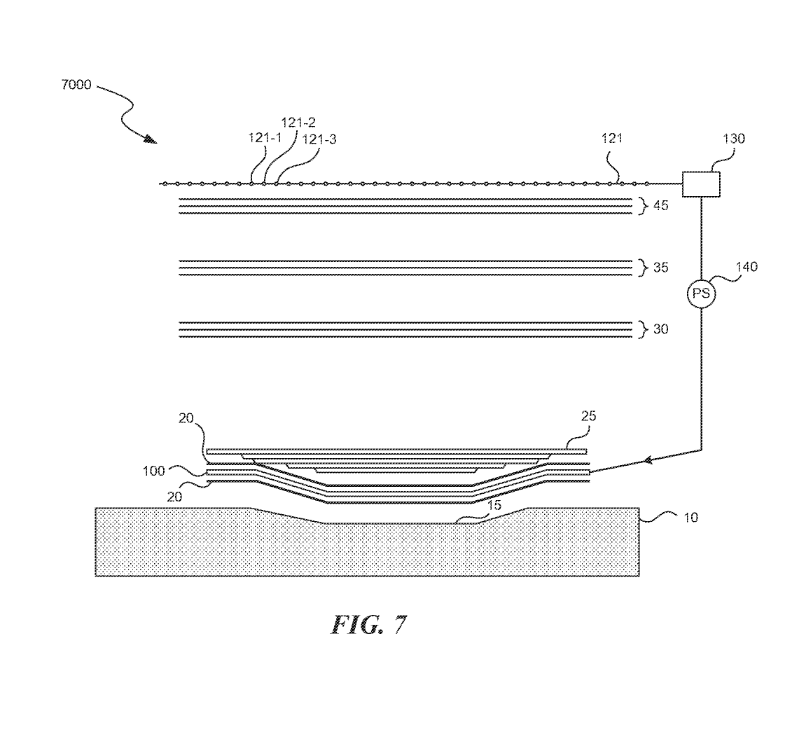

FIG. 5A is a partially schematic cross-sectional view of composite structure repair stack configured in accordance with another embodiment of the present technology. The stack 5000 is similar to the stack 3000 described with reference to FIG. 3, but the stack 5000 includes an inner temperature sensor array 120, an outer temperature sensor array 121, and does not include film adhesive. Generally, a temperature sensor array in the composite structure at least reduces the airworthiness of the composite structure, and may render the composite structure not suitable for airborne use altogether. Therefore, the inner sensor array 120 can be removed after completing relevant measurements and before applying the film adhesive, as explained in more detail below with reference to FIGS. 6 and 7.

As shown in FIG. 5A, the inner temperature sensor array 120 can be located between the embedded heater 100 and the repair plies 25. In at least some embodiments, since the inner temperature sensor array 120 occupies generally same area that will be occupied by the film adhesive, the outputs of these sensors can approximate temperatures that the film adhesive will experience. Furthermore, the outputs of the inner and outer temperature sensor array 120, 121 can be used to calculate or at least estimate thermal conductivity of the stack 5000. Suitable numerical or analytical methods may be utilized for estimating thermal conductivity of the material between two arrays of temperature arrays. As explained in more detail with reference to FIGS. 6 and 7, when the thermal conductivity of the stack 5000 is known, the temperature distribution within the stack 5000 can be more precisely controlled.

FIG. 5B is a partially schematic plan view of an embodiment of the temperature sensor array 120 of FIG. 5A, in this embodiment, the temperature sensor array 120 comprises temperature sensors (120-1, 120-2, etc.) that can include, for example, thermocouples or temperature sensitive resistors. The illustrated temperature sensor array 120 shows an example of a possible sensor layout, but many other layouts are also possible. Furthermore, the temperature sensor array 121 (shown in FIG. 5A) can include the same or different sensor layout. The outputs of the temperature sensors can be obtained by suitable supporting electronics (not shown).

FIG. 5C is a graph illustrating temperature sensor array outputs in accordance with embodiments of the present technology. The horizontal axis of the graph represents time. The vertical axis of the graph represents sensor temperature. Generally, outputs of the inner temperature sensor array (120-1, 120-2, etc.) are higher than outputs of the outer temperature sensor array (121-1, 121-2, etc.) because of the close proximity between the inner temperature sensor array and the embedded heater. Furthermore, for a given power and power density of the embedded heater, a relationship can be established among the temperatures of the sensors in the outer and inner temperature sensor arrays. Such a relationship can be useful in estimating temperature within the repair stack. For example, the temperature in the vicinity of the embedded heater can be estimated based on the temperature of the outer temperature sensor array.

FIG. 6 is a flow chart of a method for determining parameters of the embedded heater in accordance with an embodiment of the present technology. In some embodiments, the steps of the method 6000 can be executed using the repair stack 5000 illustrated in FIG. 5A. In other embodiments, however, other the method 6000 may be utilized with other suitable repair stacks. Beginning in step 605, power is applied to the embedded heater. The applied power can be uniform over the entire embedded heater or different per the segments of the embedded heater. In steps 610 and 615, the respective temperatures are obtained for the sensors of the inner and outer temperature sensor arrays. Knowing the temperatures at the opposing sides of the repair stack, the effective heat transfer properties can be calculated in step 620. In step 625, the temperatures measured by the inner temperature sensor arrays are compared to target temperature (e.g., a known uniform or close to uniform temperature that is suitable for curing a given film adhesive). If the temperatures are acceptable (e.g., sufficiently close to the target temperature), then the parameters of the process can be recorded in step 630 and the process can end in step 640. Some examples of the parameters of the process are: overall power and power density of the embedded heater, voltages of the embedded heater power supplies, and temperatures of the sensor arrays. If the temperatures are not acceptable (e.g., not sufficiently uniform, too high, too low), then the power of the embedded heater can be adjusted in step 635. For example, if the temperature at the inner sensor array is on average appropriate, but is too high in the middle of the array and too low at the periphery of the array, the power density in the middle of the embedded heater can be decreased while the power density at the periphery of the embedded heater is correspondingly increased to make the temperatures more uniform across the inner sensor array. The newly calculated power and/or power distribution of the embedded heater can be applied in step 605, and the process can be repeated until the condition in step 625 is satisfied and the parameters are recorded in step 630. In other embodiments, the method 6000 may include additional and/or different steps.

FIG. 7 is a partially schematic cross-sectional view of a composite structure repair system configured in accordance with another embodiment of the present technology. The repair system 7000 includes the embedded heater 100 between the scarfed surface 15 and the repair plies 25. One embedded heater 100 is shown, but in some embodiments the repair system 7000 can include one or more additional embedded heaters. The uncured film adhesive 20 connects the embedded heater 100 to the scarfed surface 15 at one side and to the repair plies 25 at the other side. In the illustrated embodiment, the repair plies 25 are covered by the first, second, and third cover composites 30, 35, 45, but other number and arrangements of the cover composites are also possible. The outer temperature sensor array 121 can be at the outer side of the stack of the cover composites. In operation, the embedded heater 100 is powered by a power supply 140 (shown schematically) configured to energize the embedded heater at a target voltage or energize the segments of the embedded heater at their respective target voltages. The target voltages can be provided by a controller 130 (shown schematically) based on, for example, the parameters recorded by the method 6000 described in reference to FIG. 6. The embedded heater 100 heats the film adhesive 20, which starts curing of the adhesive. In some embodiments of the present technology, the controller 130 can read temperatures of the sensors (121-1, 121-2, etc.) of the outer temperature sensor array 121. The controller 130 may compare these temperatures with the target parameters obtained by the method 6000. If, for example, the controller 130 detects temperatures at the outer temperature sensor array 121 that are higher than the corresponding target parameters, the controller can drive correspondingly lower voltage at the power supply 140. Furthermore, if the temperature distribution at the outer temperature sensor array 121 does not correspond to the target parameters, the controller 130 can change the distribution of the power density of the embedded heater 100 to get the temperature distribution back to the target. In some embodiments, based on the target parameters, the controller 130 can continuously adjust power and/or power density of the embedded heater 100 to keep the temperature of the film adhesive 20 and the repair plies 25 more uniform and closer to the target temperature. In general, the uniformity of the temperature and precision of the temperature control at the film adhesive improves the quality of the bond between the repair plies and the composite structure.

### Examples

1. A method for repairing a composite structure, the method comprising:
configuring repair plies between an inner sensor array and an outer sensor array, wherein the inner sensor array has a first side facing the repair plies and a second side facing away from the first side toward an embedded heater and a scarfed surface;
energizing the embedded heater for a first period of time;
acquiring outputs of individual sensors of the inner and outer sensor arrays;
based on the outputs of the individual sensors of the inner and outer sensor arrays, determining a desired power distribution for the embedded heater;
removing the inner sensor array; and
energizing the embedded heater for a second period of time to produce the desired power distribution, and wherein delivery of thermal energy at the desired power distribution via the embedded heater during the second period results in a selected temperature profile across the repair plies.

2. The method of example 1 wherein energizing the embedded heater for the second period results in a generally uniform temperature profile across the repair plies.

3. The method of example 1 or example 2 wherein the embedded heater is disposed between the inner sensor array and the scarfed surface.

4. The method of any one of examples 1-3 wherein the embedded heater comprises a plurality of heater elements, and wherein energizing the embedded heater for the first period of time and energizing the embedded heater for the second period of time comprise energizing the heater elements independently during both the first and second periods of time.

5. The method of example 4 wherein energizing the heater elements comprises energizing the heater elements with independently controllable voltage sources.

6. The method of example 5, further comprising:
after energizing the embedded heater to produce the power distribution required for the generally uniform temperature within the repair plies, reading the outputs of the individual sensors of the outer sensor array; and
at least in part based on the outputs of the individual sensors of the outer sensor array, controlling the voltage sources to produce the generally uniform temperature within the repair plies.

7. The method of example 4 wherein energizing the heater elements comprises providing at least one voltage source output at a voltage that is modified by a duty cycle.

8. The method of example 4 wherein the heater elements have generally different electrical resistances.

9. The method of example 4 wherein the heater elements are formed from unidirectional fibers, woven fibers, braided fibers, and/or mat fibers.

10. The method of any one of examples 1-9 wherein the embedded heater comprises carbon fibers.

11. The method of example 10 wherein the carbon fibers comprise AS4 or IM7 fibers.

12. The method of any one of examples 1-11 wherein determining a desired power distribution comprises calculating heat transfer properties within the repair plies.

13. The method of any one of examples 1-12, further comprising disposing a film adhesive between the embedded heater and the scarfed surface.

14. An apparatus for repairing a composite structure, the apparatus comprising:
repair plies configured to be arranged with a first side facing a scarfed surface and a second side facing away from the first side; and
an embedded heater configured to be positioned between the repair plies and the scarfed surface, wherein the embedded heater has a first side facing the scarfed surface and a second side facing the repair plies,
wherein the embedded heater comprises a plurality of independently controllable, electrically isolated heater elements.

15. The apparatus of example 14, further comprising voltage sources electrically connected with the corresponding heater elements.

16. The apparatus of example 14 or example 15, further comprising:
an outer sensor array configured to be arranged facing the second side of the repair plies; and
a controller operably coupled to the embedded heater and configured to control the voltage sources based on outputs of individual sensors of the outer sensor array.

17. The apparatus of any one of examples 14-16 wherein at least some of the heater elements comprise different electrical resistances.

18. The apparatus of any one of examples 14-17 wherein the heater elements are formed from unidirectional fibers, woven fibers, braided fibers, and/or mat fibers.

19. The apparatus of any one of examples 14-18 wherein the heater elements comprise carbon fibers.

20. The apparatus of example 19 wherein the carbon fibers comprise AS4 or IM7 fibers.

21. The apparatus of any one of examples 14-20 wherein the first side of the heater elements are configured to be positioned such that they contact a first film adhesive and the second side of the heater elements are configured to be positioned such that they contact a second film adhesive.

22. The apparatus of any one of examples 14-21, further comprising a plurality of independently controllable power supplies connected to corresponding heater elements.

The above detailed descriptions of embodiments of the technology are not intended to be exhaustive or to limit the technology to the precise form disclosed above. Although specific embodiments of and examples for the technology are described above for illustrative purposes, various equivalent modifications are possible within the scope of the technology. For example, although many of the embodiments are described with respect to repairs of the composite structure of an airplane, other applications are within the scope of the present technology. For instance, the present technology can be used for the repairs of the composite structures of the wind turbine vanes. Furthermore, the present technology can be used to produce the composite structures, in addition to repairing damaged composite structures. In some embodiments, changes in the electrical resistance of the embedded heater can be used to estimate the temperature of the embedded heater and the surrounding area. In some embodiments, additional embedded heaters and adhesive layers can be used between the repair plies. Moreover, in alternative embodiments, the embedded heater can be used along with conventional external heating sources. Further, while steps are presented in a given order, alternative embodiments may perform steps in a different order. The various embodiments described herein may also be combined to provide further embodiments.

From the foregoing, it will be appreciated that specific embodiments of the technology have been described herein for purposes of illustration, but well-known structures and functions have not been shown or described in detail to avoid unnecessarily obscuring the description of the embodiments of the technology. Where the context permits, singular or plural terms may also include the plural or singular term, respectively.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Additionally, the term “comprising” is used throughout to mean including at least the recited feature(s) such that any greater number of the same feature and/or additional types of other features are not precluded. It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

I/we claim:

1. A method for repairing a composite structure, the method comprising:
configuring repair plies between an inner sensor array and an outer sensor array, wherein the inner sensor array has a first side facing the repair plies and a second side facing away from the first side toward an embedded heater and a scarfed surface;
energizing the embedded heater for a first period of time;
acquiring outputs of individual sensors of the inner and outer sensor arrays;
based on the outputs of the individual sensors of the inner and outer sensor arrays, determining a desired power distribution for the embedded heater;
removing the inner sensor array; and
energizing the embedded heater for a second period of time to produce the desired power distribution, and wherein delivery of thermal energy at the desired power distribution via the embedded heater during the second period results in a selected temperature profile across the repair plies.

2. The method of claim 1 wherein energizing the embedded heater for the second period results in a generally uniform temperature profile across the repair plies.

3. The method of claim 1 wherein the embedded heater is disposed between the inner sensor array and the scarfed surface.

4. The method of claim 1 wherein the embedded heater comprises a plurality of heater elements, and wherein energizing the embedded heater for the first period of time and energizing the embedded heater for the second period of time comprise energizing the heater elements independently during both the first and second periods of time.

5. The method of claim 4 wherein energizing the heater elements comprises energizing the heater elements with independently controllable voltage sources.

6. The method of claim 5, further comprising:
after energizing the embedded heater to produce the power distribution required for a generally uniform temperature within the repair plies, reading the outputs of the individual sensors of the outer sensor array; and
at least in part based on the outputs of the individual sensors of the outer sensor array, controlling the voltage sources to produce the generally uniform temperature within the repair plies.

7. The method of claim 4 wherein energizing the heater elements comprises providing at least one voltage source output at a voltage that is modified by a duty cycle.

8. The method of claim 4 wherein the heater elements have generally different electrical resistances.

9. The method of claim 4 wherein the heater elements are formed from unidirectional fibers, woven fibers, braided fibers, or mat fibers.

10. The method of claim 1 wherein the embedded heater comprises carbon fibers.

11. The method of claim 10 wherein the carbon fibers comprise AS4 or IM7 fibers.

12. The method of claim 1 wherein determining a desired power distribution comprises calculating effective heat transfer properties within the repair plies.

13. The method of claim 1, further comprising disposing a film adhesive between the embedded heater and the scarfed surface.

14. An apparatus for repairing a composite structure, the apparatus comprising:
repair plies configured to be arranged with a first side facing a scarfed surface and a second side facing away from the first side; and
an embedded heater configured to be positioned between the repair plies and the scarfed surface, wherein the embedded heater has a first side facing the scarfed surface and a second side facing the repair plies, and
wherein the embedded heater comprises a plurality of independently controllable, electrically isolated heater elements.

15. The apparatus of claim 14, further comprising voltage sources electrically connected with the corresponding heater elements.

16. The apparatus of claim 14 further comprising:
an outer sensor array configured to be arranged facing the second side of the repair plies; and
a controller operably coupled to the embedded heater and configured to control the voltage sources based on outputs of individual sensors of the outer sensor array.

17. The apparatus of claim 14 wherein at least some of the heater elements comprise different electrical resistances.

18. The apparatus of claim 14 wherein the heater elements are formed from unidirectional fibers, woven fibers, braided fibers, and/or mat fibers.

19. The apparatus of claim 14 wherein the heater elements comprise carbon fibers.

20. The apparatus of claim 19 wherein the carbon fibers comprise AS4 or IM7 fibers.

21. The apparatus of claim 14 wherein the first side of the heater elements are configured to be positioned such that they contact a first film adhesive and the second side of the heater elements are configured to be positioned such that they contact a second film adhesive.

22. The apparatus of claim 14, further comprising a plurality of independently controllable power supplies connected to corresponding heater elements.
